(19) United States
(12) Patent Application Publication
(10) Pub. No.: US 2014/0307470 A1
(43) Pub. Date: Oct. 16, 2014

(54) DISPLAY APPARATUS

(71) Applicant: FUNAI ELECTRIC CO., LTD., Osaka (JP)

(72) Inventor: Hirofumi HORIUCHI, Osaka (JP)

(73) Assignee: FUNAI ELECTRIC CO., LTD., Osaka (JP)

(21) Appl. No.: 14/246,423

(22) Filed: Apr. 7, 2014

(30) Foreign Application Priority Data
Apr. 12, 2013 (JP) 2013-084399

(51) Int. Cl. F21V 8/00

(52) U.S. Cl. CPC G02B 6/0031; G02B 6/0073
USPC 362/609

(57) ABSTRACT

A display apparatus includes a liquid crystal panel and a backlight unit that emits light toward a back surface of the liquid crystal panel. The backlight unit includes an LED, a light guide plate which light from the LED enters through a side surface and exits through a main surface toward the back surface of the liquid crystal panel, and a reflective sheet that reflects the light. The reflective sheet includes a first reflective portion facing the side surface of the light guide plate and including a through-hole through which the LED passes, a second reflective portion connected to a first end of the first reflective portion and covering a surface of the light guide plate opposite to the main surface, and a third reflective portion connected to a second end of the first reflective portion and covering a portion of the main surface of the light guide plate.

### CROSS REFERENCE TO RELATED APPLICATION

The present application is based on and claims priority of Japanese Patent Application No. 2013-084399 filed on Apr. 12, 2013. The entire disclosure of the above-identified application, including the specification, drawings and claims is incorporated herein by reference in its entirety.

### FIELD

The present invention relates to display apparatuses for displaying images.

### BACKGROUND

Conventional display apparatuses include those equipped with edge-lit backlight units which shine light toward the back surface of the display panel, such as those found in liquid crystal television receivers (for example, see Patent Literature 1).

FIG. 10 is a cross section illustrating relevant components in a conventional display apparatus equipped with an edge-lit backlight unit. The display apparatus 100 shown in FIG. 10 is provided with an edge-lit backlight unit 104 behind the display panel 102. The backlight unit 104 includes a plurality of light emitting diodes (LEDs) 106, a wiring substrate 108, and a light guide plate 110.

The light guide plate 110 faces the display panel 102. A surface that is located on an opposite side of light guide plate 110 relative to a main surface 110a covers a reflective sheet 112 for reflecting light. The LEDs 106 are mounted on the wiring substrate 108 and face a side surface 110b of the light guide plate 110. It should be noted that white photoresist film is formed on a mounting surface 108a of the wiring substrate 108 on which the LEDs 106 are mounted. Moreover, a molded frame 114 for supporting the outer peripheral portion of the display panel 102 is provided between the outer peripheral portion of the display panel 102 and the outer peripheral portion of the light guide plate 110. Reflective tape 116 for reflecting light is attached to a surface of the molded frame 114 facing the light guide plate 110.

The distribution of the light from the LEDs 106 spreads in a solid angle about the optical axis. The narrowly distributed light from the LEDs 106 including the optical axis enters the light guide plate 110 through the side surface 110b, as the arrows drawn with solid lines in FIG. 10 illustrate. The light entering the light guide plate 110 through the side surface 110b propagates within the light guide plate 110 while reflecting off the reflective sheet 112 and the reflective tape 116, then exits through the main surface 110a of the light guide plate 110. The back surface of the display panel 102 lights up as a result of light exiting the main surface 110a of the light guide plate 110.

It should be noted that a portion of the light entering the light guide plate 110 through the side surface 110b exits back out the side surface 110b of the light guide plate 110 after reflecting off the reflective sheet 112 and the reflective tape 116, for example, multiple times. The light exiting through the side surface 110b of the light guide plate 110 reenters the light guide plate 110 through the side surface 110b by reflecting off the white photoresist film formed on the mounting surface 108a of the wiring substrate 108.

### CITATION LIST

### Patent Literature

[PTL 1] Japanese Unexamined Patent Application Publication No. 2003-279972

### SUMMARY

### Technical Problem

The following problem has been found with the above-described conventional display apparatus 100. A gap is formed between the LEDs 106 and the side surface 110b of the light guide plate 110 by design of the backlight unit 104. The light distributed at a wide angle from the LEDs 106 does not enter the light guide plate 110 through the side surface 110b and thus does not contribute to the illumination of the display panel 102, as the arrows drawn with dotted and dashed lines in FIG. 10 illustrate. As a result, a problem arises in which there is a loss of light from the LEDs 106 since the ratio of light entering the light guide plate 110 through the side surface 110b relative to the total light output from the LEDs 106 decreases.

The present invention aims to solve the above-described problem and provide a display apparatus capable of minimizing a loss of light from the light source.

### Solution to Problem

In order to achieve the above-described goal, the display apparatus according to an aspect of the present invention includes: a display panel; and a backlight unit that emits light toward a back surface of the display panel, wherein the backlight unit includes: a light source that generates the light; a light guide plate including a side surface through which the light generated by the light source enters and a main surface through which the light entering through the side surface exits toward the back surface of the display panel; and a reflective sheet that reflects the light, and the reflective sheet includes: a first reflective portion facing the side surface of the light guide plate and including a through-hole through which the light source passes; a second reflective portion connected to a first end of the first reflective portion and covering a surface located on an opposite side of the light guide plate relative to the main surface; and a third reflective portion connected to a second end of the first reflective portion and covering a portion of the main surface of the light guide plate.

According to this aspect, since the reflective sheet includes the second reflective portion and the third reflective portion, the light from the light source that is distributed widely reflects off the second reflective portion and the third reflective portion then enters the light guide plate through the side surface thereof. This makes it possible to increase the ratio of light entering the light guide plate through the side surface relative to the total light output from the light source and minimize a loss of light from the light source.

For example, in the display apparatus according to an aspect of the present invention, the backlight unit may further include a wiring substrate having the light source mounted thereon, and the first reflective portion may be disposed on the wiring substrate.

According to this aspect, since the first reflective portion is disposed on the wiring substrate, the light emitted from the side surface of the light guide plate reflects off the first reflective portion then reenters the light guide plate through the side surface thereof. This makes it possible to more effectively minimize a loss of light from the light source.

For example, in the display apparatus according to an aspect of the present invention, the side surface of the light guide plate may include a protruding portion extending toward the wiring substrate, and the protruding portion may push a predetermined region of the first reflective portion against the wiring substrate.

According to this aspect, it is possible to keep the first reflective portion from separating from the wiring substrate by having the protruding portion provided on the side surface of the light guide plate push a predetermined region of the first reflective portion against the wiring substrate.

For example, in the display apparatus according to and aspect of the present invention, the light source may include a plurality of light sources, the light sources may be arranged spaced apart from each other in a lengthwise direction of the wiring substrate, the protruding portion may include a plurality of protruding portions each disposed between a corresponding adjacent pair of the light sources, and each of the protruding portions may push a region of the first reflective portion between the corresponding adjacent pair of the light sources against the wiring substrate.

According to this aspect, when a plurality of the light sources are provided, it is possible to keep the first reflective portion from separating from the wiring substrate more effectively by having the plurality of protruding portions each push a region of the first reflective portion between the corresponding adjacent pair of the light sources against the wiring substrate.

For example, the display apparatus according to an aspect of the present invention may further include a support component provided between an outer peripheral portion of the display panel and an outer peripheral portion of the light guide plate, the support component supporting the outer peripheral portion of the display panel, wherein the third reflective portion may be sandwiched between the support component and the light guide plate.

According to this aspect, since the third reflective portion is sandwiched between the support component and the light guide plate, it is possible to secure the third reflective portion using existing components.

For example, in the display apparatus according to an aspect of the present invention, the reflective sheet may be provided with a bending portion in a boundary region between the first reflective portion and the second reflective portion and in a boundary region between the first reflective portion and the third reflective portion, the bending portion facilitating bending of the reflective sheet.

According to this aspect, since the boundary region between the first reflective portion and the second reflective portion and the boundary region between the first reflective portion and the third reflective portion are each provided with a bending portion, the reflective sheet can be easily bent along the bending portion. This makes it easier to form the reflective sheet.

For example, in the display apparatus according to an aspect of the present invention, the bending portion may be formed by perforations or a groove.

According to this aspect, it is possible to form the bending portion by perforations or a groove.

### Advantageous Effects

With the display apparatus according to an aspect of the present invention, it is possible to minimize a loss of light from the light source.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a perspective view of the front of the display apparatus according to Embodiment 1 of the present invention.

FIG. 2 is a perspective view of the back of the display apparatus shown in FIG. 1.

FIG. 3 is a cross section illustrating relevant components in the display apparatus at the line A-A illustrated in FIG. 1.

FIG. 4 is a partially exploded perspective view of the backlight unit.

FIG. 5 is a perspective view of relevant components while the reflective sheet is removed from the wiring substrate.

FIG. 6 is a plane view of the reflective sheet while flattened out.

FIG. 7 is a cross section illustrating a portion of relevant components of the backlight unit in the display apparatus according to Embodiment 2 of the present invention.

FIG. 8 is a partially exploded perspective view of relevant components of the backlight unit illustrated in FIG. 7.

FIG. 9 is a cross section illustrating relevant components of the backlight unit at the line B-B illustrated in FIG. 7.

FIG. 10 is a cross section illustrating relevant components in a conventional display apparatus.

### DESCRIPTION OF EMBODIMENTS

Hereinafter, exemplary embodiments are described in greater detail with reference to the accompanying Drawings. It should be noted that the embodiments described below show specific, preferred examples of the present invention. The numerical values, shapes, materials, structural elements, and the arrangement and connection of the structural elements etc. shown in the following embodiments are mere examples, and therefore do not limit the present invention, the scope of which is defined in the appended Claims. Therefore, among the structural elements in the following embodiments, structural elements not recited in any one of the independent claims are described as preferred structural elements, and are not absolutely necessary to overcome the problem according to the present invention.

### Embodiment 1

(Display Apparatus Structure)

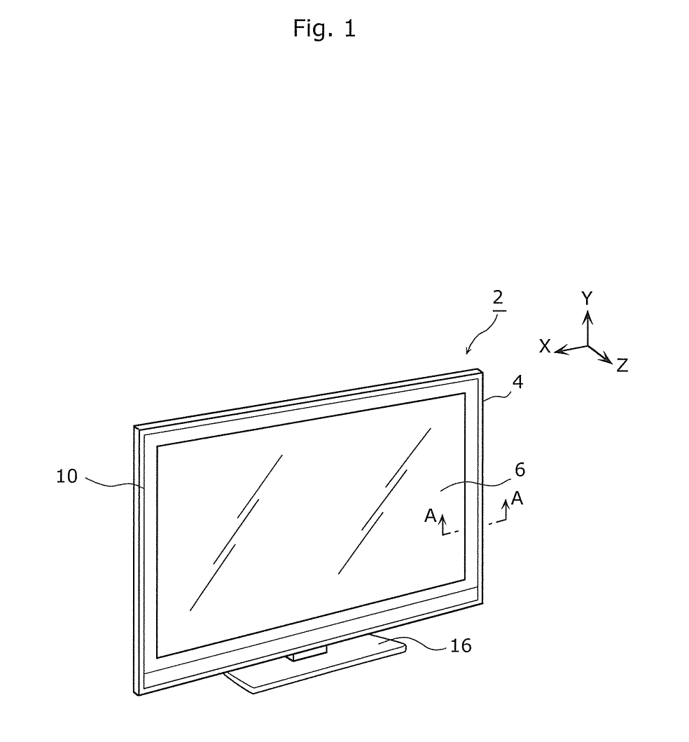

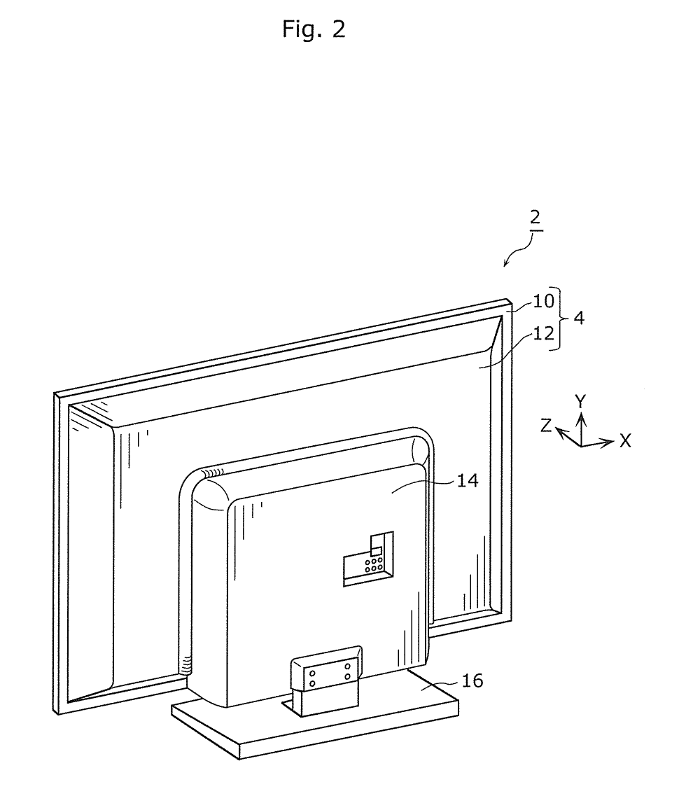

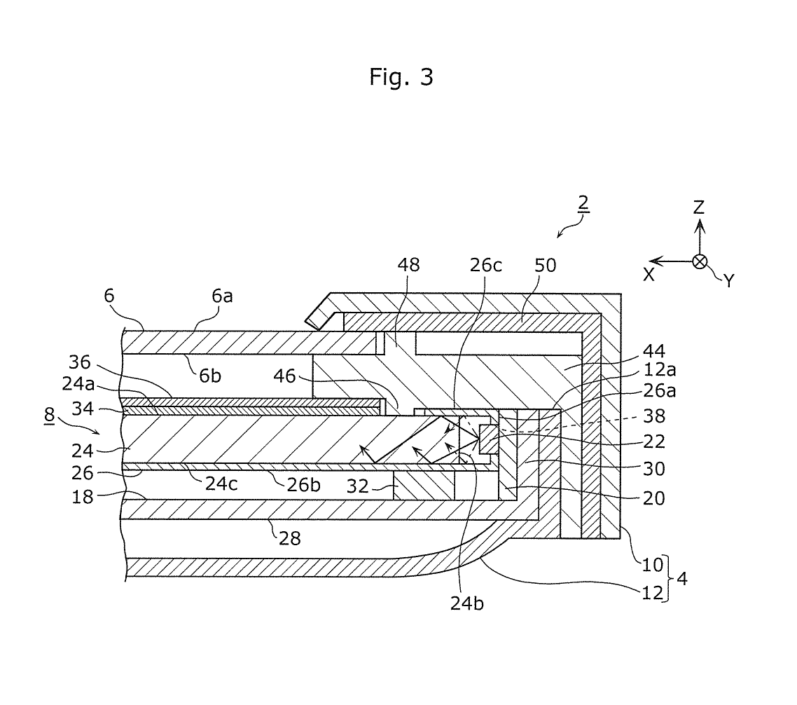

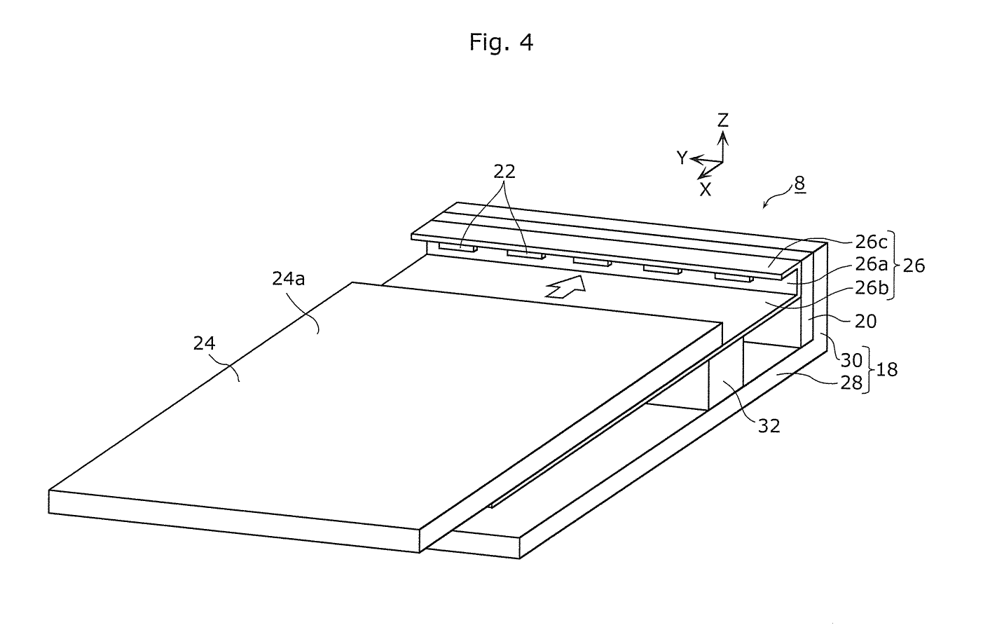

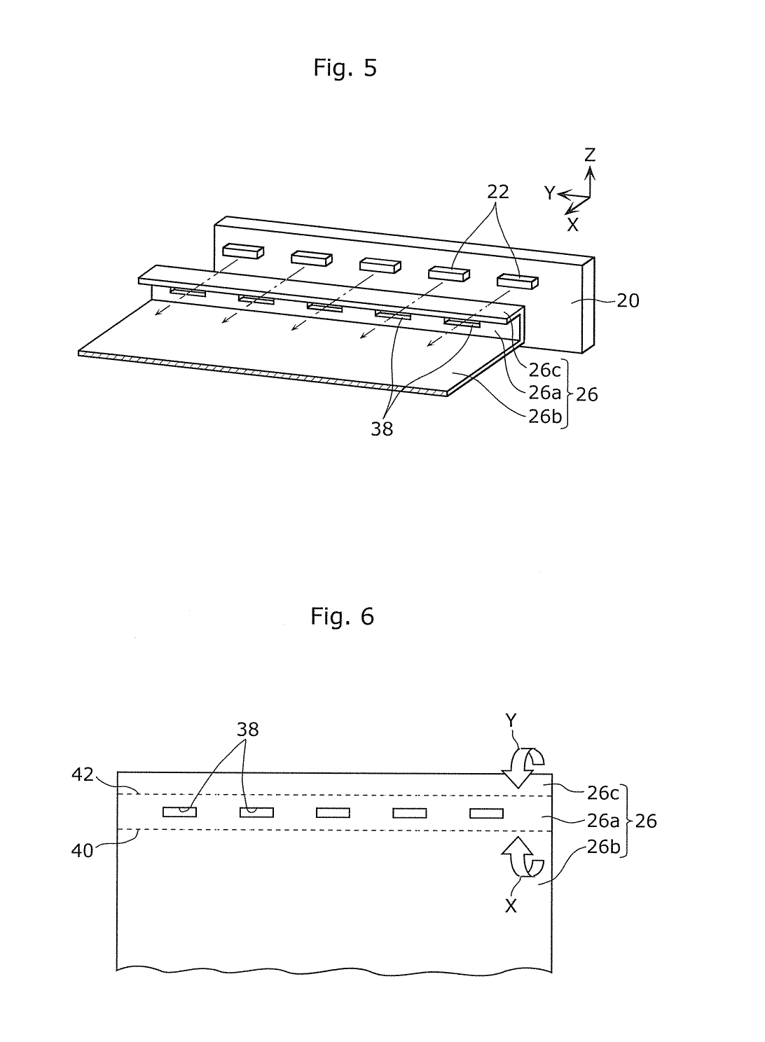

First, the structure of the display apparatus according to Embodiment 1 will be described with reference to FIG. 1 through FIG. 6. FIG. 1 is a perspective view of the front of the display apparatus according to Embodiment 1 of the present invention. FIG. 2 is a perspective view of the back of the display apparatus shown in FIG. 1. FIG. 3 is a cross section illustrating relevant components in the display apparatus at the line A-A illustrated in FIG. 1. FIG. 4 is a partially exploded perspective view of the backlight unit. FIG. 5 is a perspective view of relevant components while the reflective sheet is removed from the wiring substrate. FIG. 6 is a plane view of the reflective sheet while flattened out.

The display apparatus 2 shown in the drawings includes a housing 4, a liquid crystal panel 6 (which constitutes the display panel) provided in the housing 4, and a backlight unit 8 provided in the housing 4. The display apparatus 2 according to Embodiment 1 is a liquid crystal television receiver equipped with the edge-lit backlight unit 8.

A front cabinet 10 and a rear cabinet 12 are put together to form the housing 4.

The front cabinet 10 is arranged on the front surface 6a side of the liquid crystal panel 6. The front cabinet 10 is formed in the shape of a frame and covers the outer peripheral portion of the liquid crystal panel 6. It should be noted that the front cabinet 10 is formed from, for example, resin.

The rear cabinet 12 is arranged facing the back surface 6b of the liquid crystal panel 6. The rear cabinet 12 slightly bulges out away from the liquid crystal panel 6 and includes a rectangular opening 12a to accommodate the liquid crystal panel 6. It should be noted that the rear cabinet 12 is formed from, for example, resin.

A power source substrate and such (not shown in the drawings) that supplies power to, for example, the liquid crystal panel 6 and the backlight unit 8, is attached to the central region of the external surface of the rear cabinet 12. A rear cover 14 is attached to the external surface of the rear cabinet 12. The rear cover 14 covers the above-described power source substrate and such. A stand 16 for supporting the housing 4 from below is attached to the rear cover 14. It should be noted that the rear cover 14 is formed from, for example, resin.

As is illustrated in FIG. 3, the backlight unit 8 is supported by the internal surface of the rear cabinet 12. The backlight unit 8 receives power from the above-described power supply substrate, and shines light toward the back surface 6b of the liquid crystal panel 6. As is illustrated in FIG. 3 and FIG. 4, the backlight unit 8 includes a heat sink 18, a wiring substrate 20, a plurality of LEDs 22 (each LED 22 constitutes a light source), a light guide plate 24, and a reflective sheet 26.

The heat sink 18 includes a flat heat dissipation portion 28 and an attachment portion 30 which extends substantially vertical from one end portion of the heat dissipation portion 28 toward the liquid crystal panel 6. In other words, the heat sink 18 has a cross section that is substantially L-shaped. The heat dissipation portion 28 is attached to the internal surface side of the rear cabinet 12 with screws (not shown in the drawings). It should be noted that the heat sink 18 is made from a metal having high thermal conductivity, such as aluminum.

The wiring substrate 20 has an elongated plate-like shape. The LEDs 22 are mounted on the wiring substrate 20, arranged in a line in the lengthwise direction of the wiring substrate 20, and spaced apart from each other. It should be noted that each of the LEDs 22 is, for example, a chip-type LED. The wiring substrate 20 is attached to the attachment portion 30 of the heat sink 18 with thermally conductive double sided tape (not shown in the drawings). It should be noted that the wiring substrate 20 is made from a metal having high thermal conductivity, such as aluminum.

The light guide plate 24 is supported by the heat dissipation portion 28 of the heat sink 18 via a cushion 32 formed from, for example, a rubber material. It should be noted that the cushion 32 positionally corresponds to the outer peripheral portion of the light guide plate 24. A side surface 24b of the light guide plate 24 faces the LEDs 22. A main surface 24a of the light guide plate 24 faces the back surface 6b of the liquid crystal panel 6.

It should be noted that a diffusion sheet 34 and a lens sheet 36 are layered together and cover the main surface 24a of the light guide plate 24. The diffusion sheet 34 is an optical sheet for diffusing light emitted from the main surface 24a of the light guide plate 24. The lens sheet 36 is an optical sheet for guiding the light diffused by the diffusion sheet 34 to the back surface 6a of the liquid crystal panel 6.

Next, the structure of the reflective sheet 26, which is a characteristic structure of the display apparatus 2 according to Embodiment 1, will be discussed. The reflective sheet 26 includes a first reflective portion 26a, a second reflective portion 26b, and a third reflective portion 26c. The reflective sheet 26 is formed from, for example, polyethylene terephthalate (PET). The reflectivity of the reflective sheet 26 is, for example, 90% or higher.

The first reflective portion 26a extends in an elongated manner in the lengthwise direction of the wiring substrate 20 and covers the mounting surface of the wiring substrate 20 on which the LEDs 22 are mounted. As is illustrated in FIG. 5, a plurality of through-holes 38 which positionally correspond with the LEDs 22 are formed in the first reflective portion 26a. Each of the LEDs 22 passes through a corresponding one of the through-holes 38.

The second reflective portion 26b is connected to a first end of the first reflective portion 26a. The second reflective portion 26b extends in a direction substantially perpendicular to the first reflective portion 26a, covers a region between the wiring substrate 20 and the light guide plate 24 from the rear cabinet 12 side, and covers the entire region of the back surface 24c (the surface located on an opposite side of the light guide plate relative to the main surface 24a) of the light guide plate 24. It should be noted that the second reflective portion 26b is attached to the back surface 24c of the light guide plate 24 as a result of the above-described cushion 32 pushing the second reflective portion 26b against the light guide plate 24.

The third reflective portion 26c is attached to the second end of the first reflective portion 26a. The third reflective portion 26c extends in a direction substantially perpendicular to the first reflective portion 26a, covers a region between the wiring substrate 20 and the light guide plate 24 from the liquid crystal panel 6 side, and a region of the main surface 24a (the region at the end of the light guide plate 24 toward the wiring substrate 20) of the light guide plate 24. The length of the third reflective portion 26c in the X axis direction is shorter than the length of the second reflective portion 26b in the X axis direction.

It should be noted that a boundary region between the first reflective portion 26a and the second reflective portion 26b includes a first bending portion 40 and a boundary region between the first reflective portion 26a and the third reflective portion 26c includes a second bending portion 42, as is illustrated in FIG. 6. The first bending portion 40 and the second bending portion 42 are each formed to facilitate bending of the reflective sheet 26, and are formed by, for example, forming perforations or a groove in a straight line. The first bending portion 40 and the second bending portion 42 extend parallel to each other.

When forming the reflective sheet 26, the reflective sheet 26 starts out flattened then is bent by first folding the second reflective portion 26b along the first bending portion 40 so the second reflective portion 26b is substantially perpendicular to the first reflective portion 26a, as the arrow labeled with an X in FIG. 6 illustrates. Next, as the arrow labeled with a Y in FIG. 6 illustrates, the third reflective portion 26c is folded along the second bending portion 42 so the third reflective portion 26c is substantially perpendicular to the first reflective portion 26a. In this way, the reflective sheet 26 can easily be formed.

As is illustrated in FIG. 3, a molded frame 44 (constituting the support component) for supporting the outer peripheral portion of the liquid crystal panel 6 from the back surface 6b side thereof is attached to an opening 12a of the rear cabinet 12. The molded frame 44 is, for example, formed in the shape of a frame. A first rib 46 is provided on the surface of the molded frame 44 on the rear cabinet 12 side, and a second rib 48 is provided on the surface of the molded frame 44 on the liquid crystal panel 6 side. The first rib 46 protrudes toward the rear cabinet 12 and the second rib 48 protrudes toward the liquid crystal panel 6. The first rib 46 is for securing a gap between the molded frame 44 and the light guide plate 24 that is the size of the cumulative thickness of the diffusion sheet 34 and the lens sheet 36. This sandwiches and holds the outer peripheral portions of the diffusion sheet 34 and the lens sheet 36 between the molded frame 44 and the light guide plate 24. The second rib 48 is for securing a gap between the molded frame 44 and a bezel 50 (to be described later) that is the size of the thickness of the liquid crystal panel 6.

It should be noted that the above-described third reflective portion 26c is sandwiched between the outer peripheral portion of the molded frame 44 (the portion of the molded frame 44 outward relative to the first rib 46) and the light guide plate 24. With this, the third reflective portion 26c is attached to the main surface 24a of the light guide plate 24.

The outer peripheral portion of the rectangular liquid crystal panel 6 is supported by the inner peripheral portion (the portion of the molded frame 44 inward relative to the second rib 48) of the molded frame 44. Light from the backlight unit 8 shines on the back surface 6b of the liquid crystal panel 6 whereby an image is displayed on the liquid crystal panel 6. The outer peripheral portion of the liquid crystal panel 6 on the front surface 6a side is covered by the bezel 50. The bezel 50 is, for example, formed in the shape of a frame, and is secured to the molded frame 44 with screws (not shown in the drawings). This sandwiches and holds the outer peripheral portion of the liquid crystal panel 6 between the bezel 50 and the molded frame 44. It should be noted that the front cabinet 10 is attached to the rear cabinet 12 with screws (not shown in the drawings) so as to cover the bezel 50 and the molded frame 44.

Light is emitted from each of the LEDs 22 when the LEDs 22 are turned on. The narrowly distributed light from the LEDs 22 including the optical axis enters the light guide plate 24 through the side surface 24b, as the arrows drawn with solid lines in FIG. 3 illustrate. The light entering the light guide plate 24 through the side surface 24b propagates within the light guide plate 24 while reflecting off the second reflective portion 26b and the third reflective portion 26c, then exits through the main surface 24a of the light guide plate 24. On the other hand, the light distributed at a wide angle from the LEDs 22 enters the light guide plate 24 through the side surface 24b after reflecting off the second reflective portion 26b and the third reflective portion 26c, as the arrows drawn with dotted and dashed lines in FIG. 3 illustrate.

A portion of the light entering the light guide plate 24 through the side surface 24b exits back out the side surface 24b of the light guide plate 24b after reflecting off the second reflective portion 26b and the third reflective portion 26c, for example, multiple times. The light exiting through the side surface 24b of the light guide plate 24 reenters the light guide plate 24 through the side surface 24b by reflecting off the first reflective portion 26a.

It should be noted that the LEDs 22 generate heat when they light up. The heat from the LEDs 22 is transferred to the heat dissipation portion 28 via the wiring substrate 20, the double sided tape, and the attachment portion 30. The heat transferred to the heat dissipation portion 28 dissipates to the air.

### Advantageous Effect

Next, the advantageous effects of the display apparatus 2 according to Embodiment 1 will be described. Since the reflective sheet 26 includes the second reflective portion 26b and the third reflective portion 26c, the light distributed at a wide angle from the LEDs 22 enters the light guide plate 24 through the side surface 24b after reflecting off the second reflective portion 26b and the third reflective portion 26c. With this, it is possible to increase the ratio of light entering the light guide plate 24 through the side surface 24b relative to the total light output from the LEDs 22 and minimize a loss of light from the each of the LEDs 22.

Moreover, since the reflective sheet 26 includes the first reflective portion 26a, the light exiting through the side surface 24b of the light guide plate 24 reenters the light guide plate 24 through the side surface 24b after reflecting off the first reflective portion 26a. Since the reflectivity of the reflective sheet 26 is generally higher than the white photoresist film formed on the mounting surface of the conventional wiring substrate, it is possible to effectively cause the light reflected off the first reflective portion 26a to enter the side surface 24b of the light guide plate 24. Moreover, with the display apparatus 2 according to Embodiment 1, since the wiring substrate 20 does not include a white photoresist film formed thereon, it is possible to reduce manufacturing costs of the display apparatus 2.

### Embodiment 2

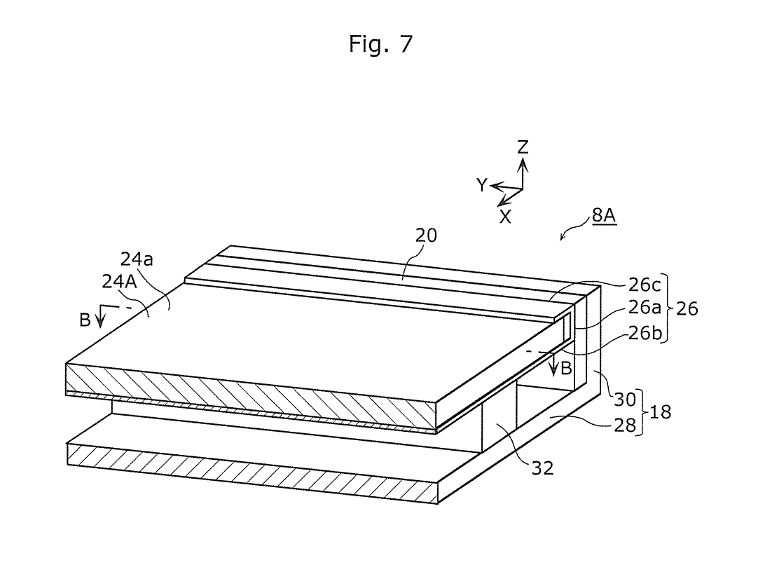

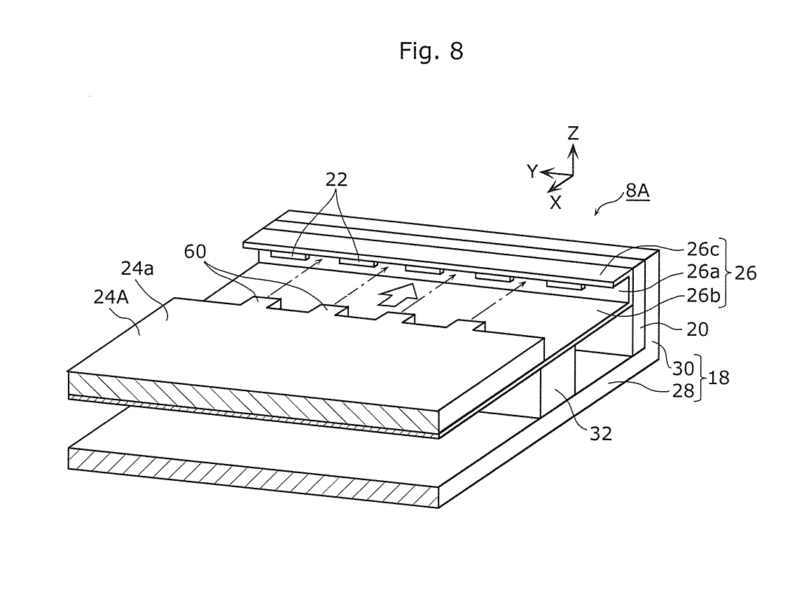

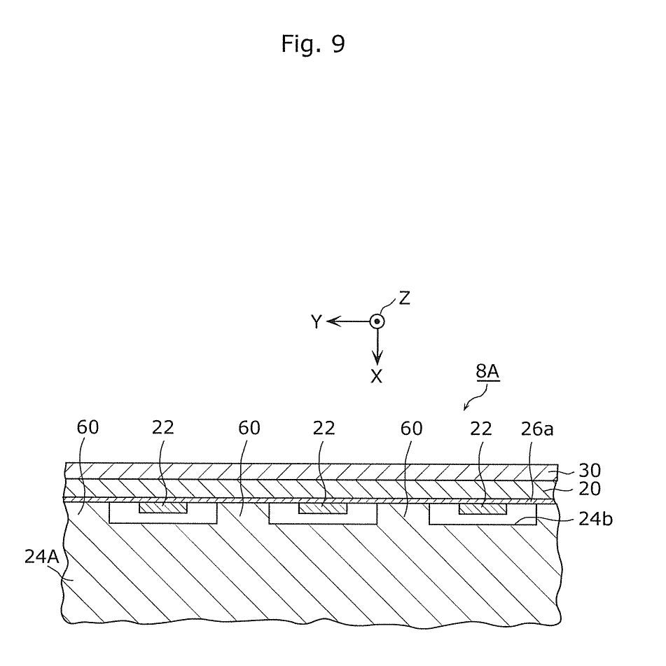

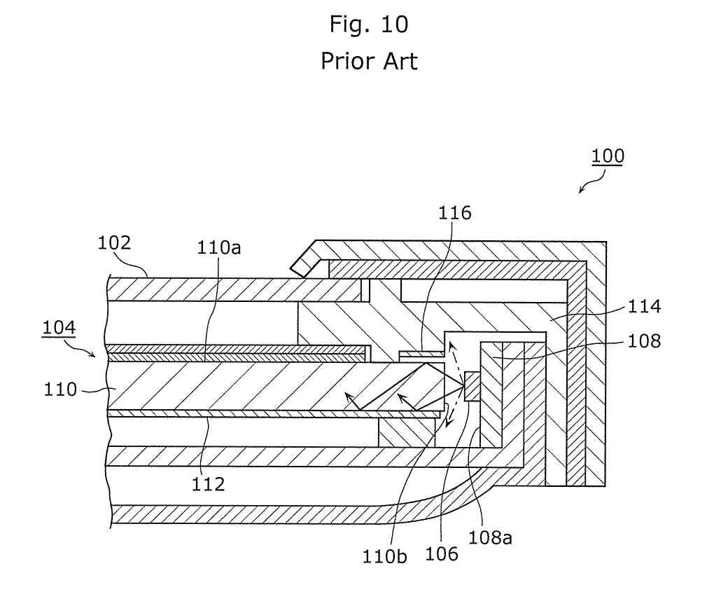

Next, the structure of the display apparatus according to Embodiment 2 of the present invention will be described with reference to FIG. 7 through FIG. 9. FIG. 7 is a cross section illustrating a portion of relevant components of the backlight unit in the display apparatus according to Embodiment 2 of the present invention. FIG. 8 is a partially exploded perspective view of relevant components of the backlight unit illustrated in FIG. 7. FIG. 9 is a cross section illustrating relevant components of the backlight unit at the line B-B illustrated in FIG. 7. Hereinafter a backlight unit 8A according to Embodiment 2 will be explained with regard to structural points of difference from the backlight unit 8 according to Embodiment 1.

As is illustrated in FIG. 8 and FIG. 9, in the backlight unit 8A according to Embodiment 2, a plurality of protruding portions 60 which extend toward the wiring substrate 20 are formed on the side surface 24b of a light guide plate 24A. Each of the protruding portions 60 is provided between a corresponding adjacent pair of the LEDs 22. Each of the protruding portions 60 pushes a region of the first reflective portion 26a between the corresponding adjacent pair of the LEDs 22 against the mounting surface of the wiring substrate 20. This makes it possible to prevent the first reflective portion 26a from separating from the mounting surface of the wiring substrate 20.

The display apparatus according to Embodiments 1 and 2 of the present invention has hereinbefore been described, but the present invention is not limited to these embodiments. For example, the above embodiments may be arbitrarily combined.

In each of the above embodiments, the display apparatus is exemplified as a liquid crystal television receiver, but the display apparatus may be, for example, a liquid crystal monitor for a computer.

In each of the above embodiments, LEDs were used as a light source for the backlight unit, but a cold cathode fluorescent lamp (CCFL), for example, may be used.

In each of the above embodiments, the backlight unit includes a heat sink, but the heat sink may be omitted. When the heat sink is omitted, the wiring substrate is attached to a rear frame formed from, for example, aluminum.

In each of the above embodiments, a plurality of protruding portions are provided on the side surface of the light guide plate, but a single protruding portion may be provided.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The display apparatus according to the present invention is applicable as, for example, a liquid crystal television receiver or a computer liquid crystal monitor.

1. A display apparatus comprising:
a display panel; and
a backlight unit that emits light toward a back surface of the display panel,
wherein the backlight unit includes:
a light source that generates the light;
a light guide plate including a side surface through which the light generated by the light source enters and a main surface through which the light entering through the side surface exits toward the back surface of the display panel; and
a reflective sheet that reflects the light, and the reflective sheet includes:
a first reflective portion facing the side surface of the light guide plate and including a through-hole through which the light source passes;
a second reflective portion connected to a first end of the first reflective portion and covering a surface located on an opposite side of the light guide plate relative to the main surface; and
a third reflective portion connected to a second end of the first reflective portion and covering a portion of the main surface of the light guide plate.

2. The display apparatus according to claim 1,
wherein the backlight unit further includes a wiring substrate having the light source mounted thereon, and
the first reflective portion is disposed on the wiring substrate.

3. The display apparatus according to claim 2,
wherein the side surface of the light guide plate includes a protruding portion extending toward the wiring substrate, and
the protruding portion pushes a predetermined region of the first reflective portion against the wiring substrate.

4. The display apparatus according to claim 3,
wherein the light source includes a plurality of light sources,
the light sources are arranged spaced apart from each other in a lengthwise direction of the wiring substrate,
the protruding portion includes a plurality of protruding portions each disposed between a corresponding adjacent pair of the light sources, and
each of the protruding portions pushes a region of the first reflective portion between the corresponding adjacent pair of the light sources against the wiring substrate.

5. The display play apparatus according to claim 1, further comprising
a support component provided between an outer peripheral portion of the display panel and an outer peripheral portion of the light guide plate, the support component supporting the outer peripheral portion of the display panel,
wherein the third reflective portion is sandwiched between the support component and the light guide plate.

6. The display apparatus according to claim 1,
wherein the reflective sheet is provided with a bending portion in a boundary region between the first reflective portion and the second reflective portion and in a boundary region between the first reflective portion and the third reflective portion, the bending portion facilitating bending of the reflective sheet.

7. The display apparatus according to claim 6,
wherein the bending portion is formed by perforations or a groove.
